(19) United States
(12) Patent Application Publication
(10) Pub. No.: US 2006/0093792 A1
(43) Pub. Date: May 4, 2006

(54) Method of producing faux embossments on business communication substrates and products produced thereby

(76) Inventor: Jesse D. Crum, Fort Scott, KS (US)

Correspondence Address: WARD KRAFT, INC., P.O. BOX 938, FORT SCOTT, KS, 66701, US

(21) Appl. No.: 10/980,347

(22) Filed: Nov. 3, 2004

(51) Int. Cl. B32B 3/00

(52) U.S. Cl. 428/172

(57) ABSTRACT

The present invention relates to business communication documents and intermediates which have a faux embossment. The faux embossment is created through the application of a curable coating to a substrate, such as through the application of ultraviolet radiation to the coating, after a pattern has been created in the coating. Curing of the coating creates a semi-permanent to permanent pattern resembling conventional embossments.

### CROSS-REFERENCES TO RELATED APPLICATIONS

None.

### FIELD OF THE INVENTION

The present invention is found in the field of substrate production, more specifically the creation of aesthetic elements or features that are applied to substrates, such as cellulosic substrates for use in preparing business communication pieces. More particularly the embodiments of the invention pertain to a method of applying a coating to a surface of a material, creating an image in the coating while the coating is still in a fluid state and then curing the coating to create a semi-permanent three dimensional image which resides on the substrate outer surface and is tactilely discernable from the remainder of the sheet.

### BACKGROUND OF THE INVENTION

The application of textures or finishes to substrates, particularly paper or cellulosic based materials is relatively well known in the art. In the conventional process of finishing or preparing paper substrates, the paper can undergo processing almost immediately as it comes off the drier of the machinery (the machinery that is involved in collecting the fibers, pressing and removing the moisture) or the paper can be collected and undergo further finishing or processing at a later time to create papers for specific uses or applications. Such later processing may include calendaring or super calendaring (the passage of the paper through steel rolls which produces a smoothness or glossiness on the surface of the paper). The amount and type of calendaring permits the surface of the substrate to vary greatly in smoothness. Exemplary types of finishes include antique, eggshell, vellum, smooth and luster (placed in order of increasing smoothness).

Other types of finishes can also be applied to the paper, such as embossing, after it leaves the paper making apparatus. Embossing is typically accomplished through the use of a rotary embosser, which impresses a particular pattern through the use of pressure rollers into the dry paper. That is, the sheet is fed through a nip which will have steel rollers that are used to press the pattern into the paper by deforming the surface of the paper, or mechanically crushing or crimping the paper. Common examples of embossed papers include tweed, linen and pebble, which represent regular patterns of impressions created in the surface of the sheet of material and provide some level of tactile detection. Such embossed papers can be difficult to image as the embossments create a discontinuous surface making the printing appear blurred as the ink or toner traverses the surface of the sheet and the ridges and valleys created by the embossing equipment.

Conventionally embossed papers also suffer from the further draw back that each pattern requires a different set of steel rollers to be cut to achieve the desired design for the end user. Preparation of such rollers can cost hundreds if not thousands of dollars as rollers will wear down over time. In addition, a manufacturer would be required to hold large inventories of such rollers in order to offer a variety of patterns, which obviously consumes an inordinate amount of space which could be used for other things such as manufacturing.

Attempts have been made to manufacture paper sheets with patterns, such as those used in creating veneers without using the conventional mechanical embossing technique described above. U.S. Pat. Nos. 4,532,157 and 4,652,482 use a relatively complex system in which multiple coatings (inks and resins) are applied to areas or alternatively are washed from areas which have not been impregnated with a particular resin and then the selected areas are overprinted with inks to produce the desired appearance. The paper is then permitted to dry for a period of time (two months—see examples) and then the sheets are lacquered to produce a wood grain pattern in the sheet. The sheets produced are used for veneers for furniture and paneling.

U.S. Pat. No. 5,246,785 describes a further process of creating a pattern on the surface of a sheet for use in creating veneers and the like such as may appear in connection with paneling and furniture. The reference includes the relatively complex application of a series of resins and inks in selected areas to accomplish the objective of producing the particular pattern of interest which is then dried and applied to the panel or furniture.

The use of embossed papers is limited in the field of business communication due primarily to cost and other difficulties such as printing an image in the area of the embossments. Embossed papers, such as linen are often several times more expensive than papers which have not been embossed and because of the difficulty with printing are often used as external panels of booklets and the like. Thus, application or use of embossed papers has been largely limited to those projects where marketing budgets are sufficient to cover the additional expense or where the product or service can simply demand the additional cost associated with the use of the papers, such as with greeting cards where it is not unusual to pay several dollars per card.

As embossed papers are attractive and would aid in the delivery of a marketing or advertising message, it has been suggested that if an economical and efficient process were available, that such patterned papers would be more widely used and accepted in the industry. Therefore, what is needed is an efficient manner by which to create a substrate or business communication document that has the appearance of being constructed from an embossed sheet without the disadvantages of cost or time to produce such documents or problems with applying an image to the document that is to be used for the communication piece.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is directed to an efficient and economical method by which to manufacture paper and other substrates having the appearance of a conventionally embossed surface. It has been found that through the use of a curable coating that is applied to a suitable stock of material, which may be pre-printed with information related to an end user or customer, that three dimensional and tactilely discernable patterns can be readily and reliable created and repeated in both cut sheet and continuous stock applications.

In one exemplary embodiment of the presently described invention, a business communication document that has a faux embossed pattern is described and includes a cellulosic substrate that has first and second faces and first and second longitudinally extending sides and first and second transversely extending ends. The substrate has a basis weight of at least 20 pounds. The presently described embodiment also includes a coating that is applied to at least a portion of one of the first and second faces. The coating remains substantially on the face of the substrate and does not diffuse into the substrate. A faux embossed pattern is created on the surface of the substrate by pressing a pattern into the coating while the coating is still in a wet stage. The coating is then cured in order to harden the pattern through application of radiation, such as ultraviolet radiation, to convert the coating to a semi permanent faux embossed pattern that has a raised, three dimensional image. The pressure that is applied to the coating is sufficient to impart the pattern to the coating but not so significant as to squeeze the coating off the sheet.

In a further exemplary embodiment of the present invention, a method of producing a faux embossed business communication document is provided and includes the steps of initially providing a substrate that has a basis weight of greater than 20 pounds. The substrate is then advanced to a first coating station and a coating is applied to at least a portion of the substrate to create a partially coated substrate, the coating is applied in a wet or fluid state. Next, the coated substrate is advanced to a second station that is distinct and downstream from the first station. A raised pattern is then created in the coating by contacting a plate with the coating on the coated substrate to create a pattern impressed coated substrate. The pattern impressed coated substrate is then passed or advanced to a third station, that is distinct from each of the first and second stations and downstream from the stations. The pattern impressed substrate is then cured to create a business communication piece that has a faux embossment with a raised, three dimensional image. Finally, the faux embossed business communication piece is collected and may be subjected to additional processing.

In addition to practicing the foregoing method, the substrate may be printed with indicia that is related or unique to the end user or requester of the substrate. The printing of the substrate would preferably occur prior to the application of the coating, but it is within the scope of this invention that printing may be applied after the curing of the coating has been accomplished.

The substrate of the present invention may also undergo additional processing steps such as folding, cutting, perfing, or may have pockets applied such as with the creation of a presentation folder, application of labels or cards, and the like.

In a yet still further exemplary embodiment of the present invention, an intermediate that has a faux embossment is described and includes, a substrate that has a basis weight of greater than 20 pounds. The substrate has first and second faces. In this exemplary embodiment, a radiation curable coating is applied to at least a portion of one of the first and second faces that define a coated area. The coating that is applied to the substrate remains substantially on the face or exterior of the substrate. A raised three dimensional tactilely discernable pattern is created in the coated area, by contacting the coating with a plate, to create a faux embossment. The substrate with the faux embossment is used to create business communication document.

In a further exemplary embodiment of the present invention, a method of producing marketing collateral having faux embossments, is described and includes the steps of initially creating a pattern unique to an end user. The pattern is selected from a group including strips, lines, shapes, spots, dots, elements, discontinuous segments, themes, seasons, events, trade dress, graphics, alpha and numeric characters and combinations thereof and generally will however contain attributes that can be used to identify the end user or purchaser of the marketing collateral.

Next, a plate is prepared that contains the pattern. A suitable substrate is provided. The suitability of the substrate is determined based on the use or application to be made of the substrate. Next, a curable coating is applied to at least a portion of the substrate. The plate, which may be a conventional flexo plate is applied to the coating or contacts the coating with sufficient pressure to create the pattern in the coating, by displacing portions of the coating on the substrate. Then, the coating is cured to create at least a semi permanent, tactilely discernable pattern on the substrate.

In the foregoing embodiments the business communication document or intermediate may be provided in a continuous or cut sheet format. The document or intermediate can undergo various supplemental steps such as printing, folding, cutting, perfing and the like to finish the document for acceptance by the end user.

The business communication document or intermediate can be used to create a variety of communication pieces including presentation folders, advertising and marketing collateral, sell sheets, invitations, business forms, stationery and combinations thereof.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts an exemplary intermediate suitable for creating business documents that is prepared using the process of the present invention;

FIG. 1A presents a side view of the business communication document of the present invention showing the raised, tactilely distinct pattern created through the use of the coating of the present invention.

FIG. 2 shows an alternative embodiment in which a business communication document is provided with a coated portion of the surface;

FIG. 2A depicts a presentation folder prepared from a stock created through use of the presentation folder;

FIG. 3 provides a block diagram of an exemplary method of using the invention;

FIG. 4 illustrates a schematic of the apparatus used in carrying out the present invention; and

FIG. 5 depicts a further block diagram showing a method for preparing marketing collateral using the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been discovered that patterns not only those which resemble traditional embossments but also unique configurations can be created without the need to create expensive overlays, bases or the necessity of calendaring methods heretofore previously known. In addition, through the use of the present embodiments it has been discovered that a significantly higher degree of variability can be provided to the end user.

The term “patterns” as used herein refers to continuous strips, lines, shapes, spots, dots, elements, discontinuous segments as well as regular and irregular placement of such items. Patterns may also refer to combinations of the above mentioned items such that one pattern may be a continuous strip, another segmented elements and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters and the like. For example, one may wish to include a name of a company in connection with a particular theme or season.

The term “basis weight” as used herein is the weight in pounds of a ream (500 sheets) of paper cut to a given standard size for that grade. For example 500 sheets of 8½″ by 11″ of bond paper weighs 20 pounds.

As used herein the term “business communication piece or document” is used to refer to a substrate that either alone or in combination with other documents can convey a particular message, image or information about a particular product or service that is available from the provider of such pieces or documents. Business communication documents or pieces can include business forms, stationery, business cards, advertising, sales and marketing collateral and such other items used to convey information in a written or imaged form.

The coating used in the present invention may be applied by flood coating, pattern or spot coating, transfer coating or other means known in the industry. The coating may be applied so as to cover the full length and width of the material or substrate or may be applied in predetermined or selected areas so that only a portion of the substrate or sheet is provided with the faux or pseudo embossment.

The thickness of the coating ranges from about 0.0002″ to about 0.005″ and more preferably 0.0002″ to about 0.003″ with about 0.002″ being yet still more preferred. Typically, in a preferred embodiment the coating is applied through a flood coat sleeve or printing plate applicator. A particular range of viscosities is generally not required however those coatings with a higher viscosity will typically produce a greater contrast between the sheet or substrate and the coating that is employed.

For the exemplary embodiment being presently described, one preferred coating is a UV curable varnish, such as FT30LI available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1) and a vapor pressure of less than 1 (MM HG at 25° C.).

The coating material may comprise 100% of the varnish or the varnish of the exemplary embodiment may contain from 0.1% to 99.9% varnish and then a second component may be provided in a range from 0.1% to 99.9%, with such second coating including pigments, dies, starches, waxes, silicones, stabilizers, drying aids, fragrances and such other elements or components that may add desirable features or characteristics to the coating.

Other coating material or components that may be suitable in connection with the practice of the present invention include Transwhite 36 and 61 are available from Arcar Graphics, LLC of West Chicago, Ill. and is water based, pigment less ink that includes butyl alcohol, ammonium hydroxide and n-methylpyrrolidone. Transwhite is generally pigment less, but pigments may be added to supplement or compliment the printing that may be applied to the assembly. NuCoat 8320 is available from NuCoat, Inc. of Plymouth, Minn. which serves as an absorbing agent. PrintAide is available from Arcar Graphics of Ann Arbor, Mich. and includes 2-dimethylaminothanol and ammonia and functions as a drying agent or wetting agent in slowing the drying if necessary. StabilAide may be mixed with water or any other known component or used alone and is available from Arcar Graphics of Ann Arbor, Mich. and is generally used for pH stabilization.

Sericol is available from Sericol of North Kansas City, Kans. and includes acrylate ester, vinaly monomer, acrylated urethane, alkanol amine, barium sulfate and a photoinitator. Sericol is a pigment less material having an absorbing agent contained therein as well as being in a prescribed pH range.

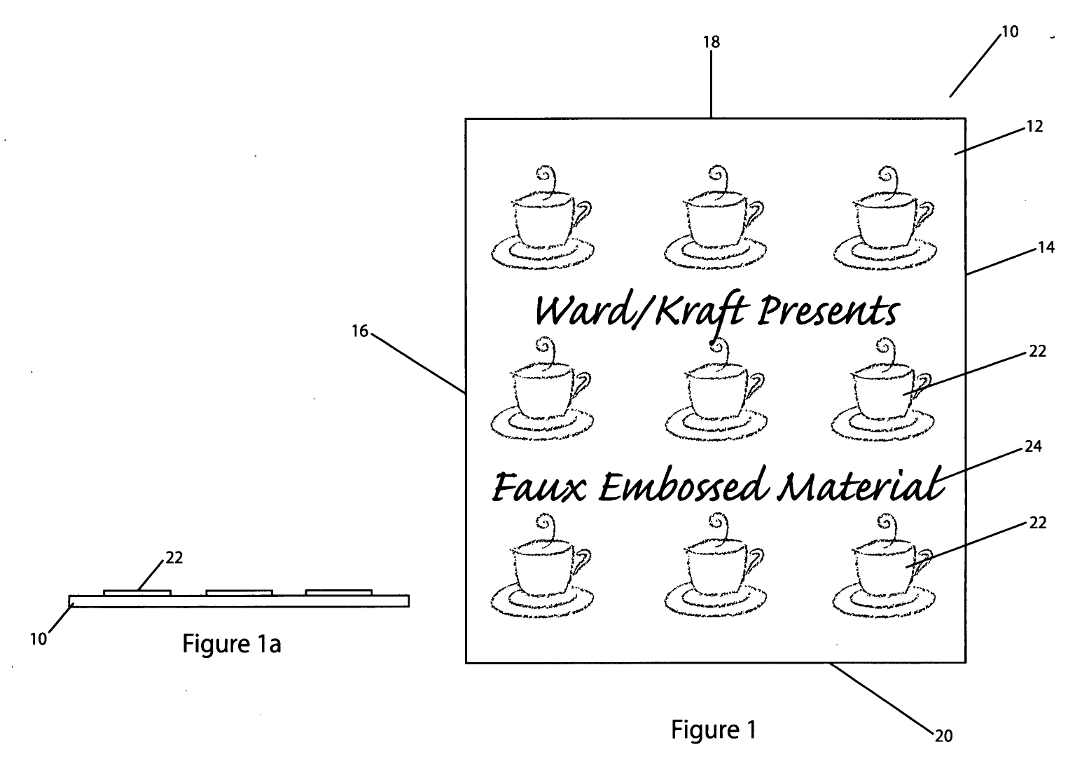

Turning now to FIG. 1, the business communication document of the present invention is generally depicted by reference to numeral 10. The substrate that has been selected is generally a cellulosic based material and may comprise a stock having a basis weight of at least 20 pounds. Preferably, the stock material will have a range from 20 pound to 100 pound tag or card stock or other substrates ranging from about 2 mil thickness to about 30 mil thickness. The heavier stocks are used for items such as presentation folders, cards and the like while lighter stocks may be used for advertising collateral such as sell sheets, business forms, stationery and the like. While cellulosic material is preferred, other materials may be used in the practice of the present invention, such as synthetic or metal films.

The substrate 10 has first 12 and second faces, first and second longitudinal sides 14 and 16, respectively, and first and second transverse edges 18 and 20 respectively. The substrate 10 is provided with a pattern 22 here represented by a number of dimples or the like that are created through the application of a coating and its subsequent curing as will be hereinafter described. In addition, the substrate 10 of the present invention may also be provided with printing 24 which is preferably applied prior to the application of the coating. However, it is within the scope of the invention that the printing may be applied after the curing step so that the printing is applied over the coating. In such instances, it may be necessary to provide an ink or toner anchorage component either prior to or simultaneously with the printing.

The printing provided in accordance with the present invention may be accomplished by any conventional method such as ink jet, laser printer, ion deposition and other means known in the art.

FIG. 1A presents a side view of the substrate 10 of the present invention so as to be able to better illustrate the three dimensional and tactilely discernable patterns 22 as prepared in the present invention. It should be understood that repetitive cup pattern is provided to demonstrate any sort of pattern which may be used depending on the requirements of the end user or customer.

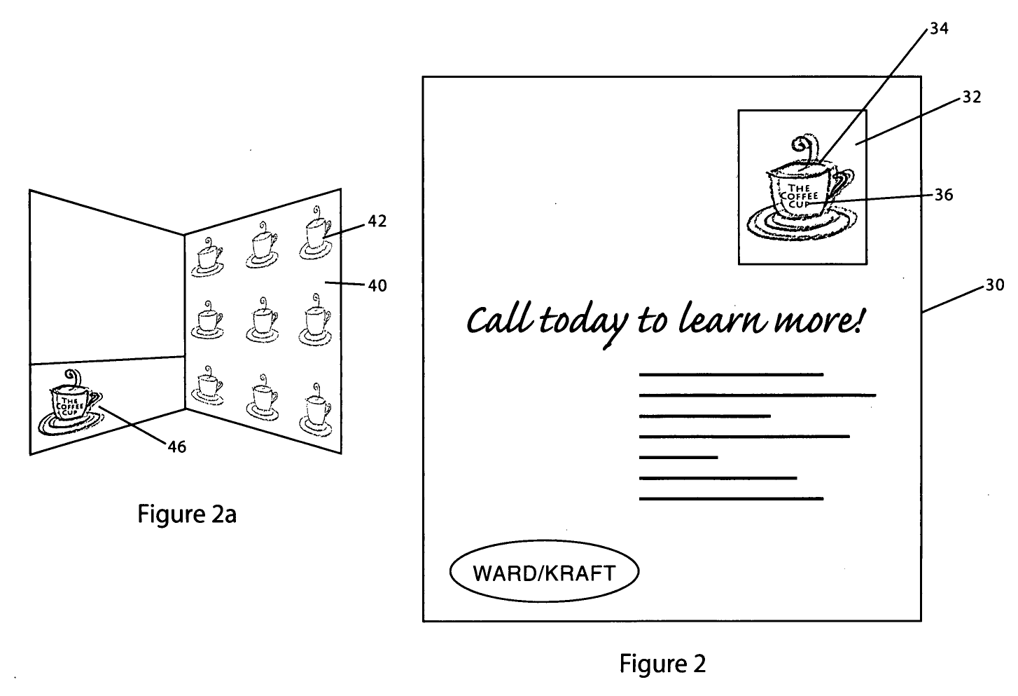

Attention is now directed to FIG. 2 of the present invention, in which an intermediate suitable for use as a business communication piece or document is represented by reference numeral 30. In this illustrate only a portion of the substrate 30 is coated with a substance 32 that is capable of being used to create a pattern 34. As presented in the present illustration the pattern that is used includes a plurality of different elements such as bars 34 and a trade name 36. In this manner, the faux embossments of the present invention can be used to present more than just a tactilely discernable pattern but also used to display information.

FIG. 2A is presented to show a presentation folder 40 that is formed from a substrate prepared in accordance with the present invention. In this drawing FIGURE, a series of distinct patterns (distinct sizes) are applied to the substrate to create a unique marketing or presentation folder. One panel of the folder 42 is provided with a full coat so as to be able to create a panel having a pattern extending about the entire surface area, whereas the other panel is provided as a selected area 46 for the coating to be applied. In this manner, the message and appearance of the intermediate or business communication document can be provided with different, distinct patterns to create or enhance the particular image of the product.

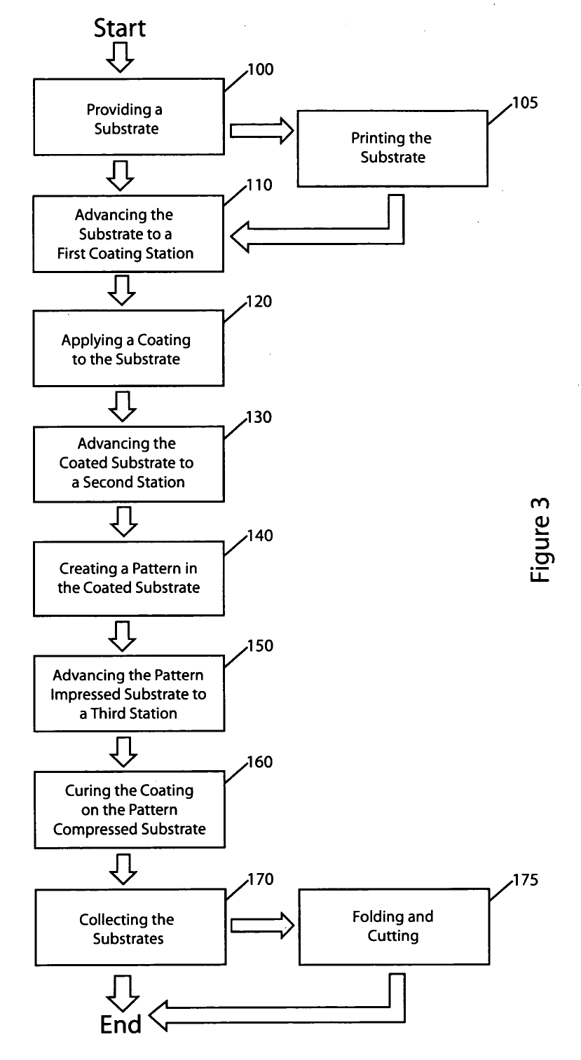

FIG. 3 presents a block diagram of an exemplary method of creating business communication documents or pieces as used in the present invention. Initially, a substrate is provided at step 100. As described previously, the substrate is preferably a cellulosic stock having a basis weight of at least 20 pounds. The substrate is advanced at step 110 to a first station that is used to apply the coating to the substrate.

Next, the coating is applied to the substrate at step 120. The coating in an exemplary embodiment is a varnish which may have one or more additives such as pigments added to the coating so as to distinguish the pattern from the substrate to which it has been applied. In a preferred embodiment of the present invention, the coating is applied through the use of a flood coated sleeve.

The now coated substrate is then advanced to a second station at step 130 which is distinct and downstream from the first station. The second station is used to apply the pattern to the coated substrate at step 140. At this point, the coating is still wet and in a fluid state. Depending on the viscosity of the coating that is used, the time between stations can be very short (a few seconds to fractions of a second) or may be increased to allow the coating a chance to dry slightly. In any event, the coating will preferably stay on the surface of the substrate and will not penetrate the surface.

The pattern is applied through the use of rubber or photopolymer plates and exemplary plates are produced under the names Ekaslon RB Cor or Cyrel Dupont, available from Elaslon of San Marcos, Calif. and DuPont, Wilmington, Del., respectively. The pressure of application used is equivalent to that used in conventional flexographic printing and is not significantly strong such that the coating is squeezed out or away from the surface of the substrate. Through the use of such plate material, the manufacturer can relatively inexpensively create plates with various designs and configurations so as to create patterns that are tailored specifically for the end user.

After the substrate has the pattern created in the coating of the substrate, the sheet is again advanced at step 150 to a third station which is distinct and downstream from the first and second stations. The substrate with the coating applied thereon and a pattern impressed therein is cured at step 160. The curing is accomplished through UV bulbs as described below. Once the substrate has been cured, the substrates are collected at step 170 and the process is then completed.

In addition to the foregoing steps, the substrate may be printed at step 105 which is preferably done at any time before the coating is applied. As previously indicated, printing may also be accomplished after the curing step, however it will likely be necessary to utilize an ink or toner anchorage component so that the printing will adhere to the surface of the coating and not be easily rubbed or scuffed off.

Other post coating and curing steps may also be utilized in connection with the present process. Such additional processing can be accomplished at step 175 and may include folding, cutting, perfing, such as that which may be necessary to prepare a presentation folder or other business communication piece.

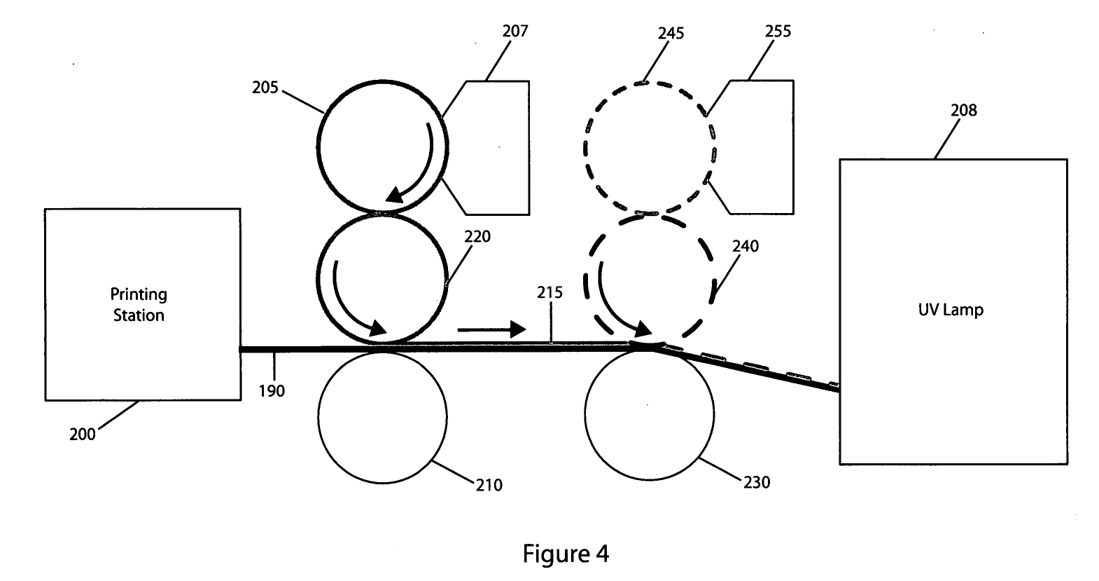

Attention is now directed to FIG. 4 where a schematic of the apparatus used to prepare the business communication piece or document is illustrated. A manufacturing 190 is used to convey and advance the substrate through each of the various processing stations as will be described. The substrate first encounters a print station 200, if one is provided, which will apply printed and other information to the surface of the substrate. Such printing may be accomplished generally through non-impact printer such as ink jet or later printers or rotary printing methods for inline printing.

The substrate is coated through the use of a flood coat sleeve-roller 220 which is supplied through an anilox roller and fountain 205 and 207 respectively. The substrate is brought into contact with the flood sleeve through use of a cooperating roller 210. The substrate with the coating applied is shown by reference numeral 215. As indicated previously, the coating may be applied across the entire surface of the substrate or only in selected areas.

The sheet is advanced in the direction of machine travel and then contacts the pattern roller 240, to which a rubber or other type of flexo plate has been applied. Again a biasing roller 230 is used to press the substrate into operative contact with the pattern roller 240 so that the pattern can be applied to the coating or coated area where the entire surface of the substrate has not been coated. Only pressure that is sufficient to press the pattern into the coating is necessary, and the amount of pressure is equivalent to that used in flexographic printing processes.

The substrate is then advanced, again in a machine direction to a curing station 250 where one or more curing lamps are used to apply curing energy to the coating on the substrate and harden the coating as to create a tactilely discernable, three dimensional pattern.

Still referring to FIG. 4, a cleaning roller 245 may be added to collect or clear excess coating from the plates. The excess coating may then be collected in a reservoir 255 or other suitable structure.

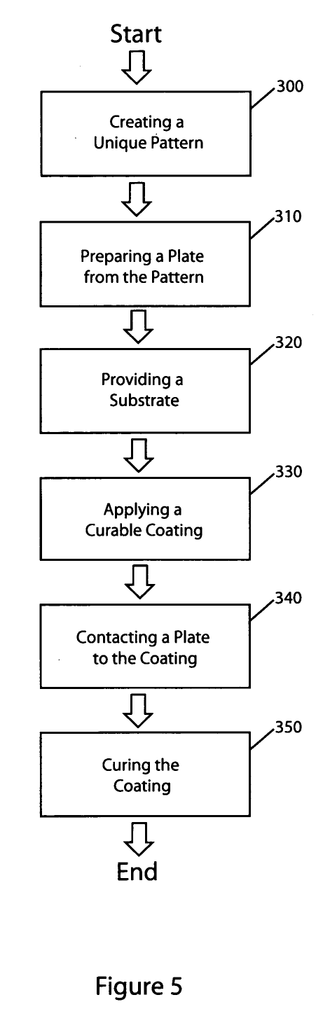

Turning now to FIG. 5, another block diagram is presented which illustrates a further exemplary method of practicing the present invention. Initially, at step 300 a pattern is created in a plate and a plate is prepared at step 310. The pattern may be determined through consultations with the customer or through copying or reproducing a particular image or pattern that the customer requests.

Next, a substrate is provided at step 320. The substrate when creating marketing collateral for example will be a generally smooth sheet that will have some level of glossy appearance. A coating is applied to the substrate at step 330 and then the coating is contacted with the plate having the pattern at step 340. Finally, the coating with the pattern resident therein is cured at step 350.

In situations where a second or multiple patterns are to be applied, either multiple plates may be used or different stations to apply subsequent patterns are set up. In this way, the consumer is not limited to the use of a single pattern as may be necessary when purchasing conventional stock.

Once the substrate has been created with the coating applied thereto and it has been cured, the sheet is in an intermediate condition in that the sheet or coated substrate will need to be subjected to at least one additional step prior to being ready for use. The intermediate sheet or substrate can be collected for later processing such as the folding and cutting that may be necessary to create a presentation folder or alternatively assembling additional pieces to be used in connection with the business communication document or piece.

The curing of the coating as used in the present invention is accomplished by at least one if not multiple UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration, can be used. In an exemplary embodiment, a single bulb may allow a UV cure rate of approximate 50 feet per minute, while plural bulbs disposed in a side-by-side or adjacent configuration permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulb suitable for use in the UV curing processes, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention. It should be understood that other curing technologies may be used in the preparation of the coating on the substrate for the present invention.

The exemplary coating normally creates a glossy finish and can be further manipulated through the addition of pigments, dyes, starches, etc. to produce a dulled or matte finish in the final product or a coating having a particular color or appearance.

It will thus be seen according to the present invention a highly advantageous method for producing business communication documents with faux embossments and products produced thereby has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business communication document having a faux embossed pattern, comprising;
a cellulosic substrate having first and second faces and first and second longitudinally extending sides and first and second transversely extending ends and having a basis weight of at least 20 pounds;
a coating applied to at least a portion of one of said first and second faces, said coating remaining on said face; and
a faux embossed pattern created by pressing a pattern into said coating while said coating is still in a wet stage and then curing said pattern through application of radiation to convert said coating to a semi permanent faux embossed pattern having a raised, three dimensional image.

2. A business communication document as recited in claim 1, wherein said business communication document is a presentation folder.

3. A business communication document as recited in claim 1, wherein said business communication document is selected from a group including advertising and marketing collateral, sell sheets, invitations, business forms, stationery and combinations thereof.

4. A business communication document as recited in claim 1, wherein said document is provided in a cut sheet format.

5. A business communication document as recited in claim 1, wherein said document is provided in a continuous format.

6. A business communication document as recited in claim 1, wherein said pattern is selected from a group including strips, lines, shapes, spots, dots, elements, discontinuous segments, themes, seasons, events, trade dress, graphics, alpha and numeric characters and combinations thereof.

7. A method of producing a faux embossed business communication document, comprising the steps of;
providing a substrate having a basis weight of greater than 20 pounds;
advancing said substrate to a first coating station;
applying a coating to at least a portion of said substrate to create a partially coated substrate;
advancing said coated substrate to a second station distinct from said first station;
creating a raised pattern in said coating by contacting said coating with a plate on said coated substrate to create a pattern impressed coated substrate;
advancing said pattern impressed coated substrate to a third station, distinct from each of said first and second stations;
curing said pattern impressed coated substrate to create a business communication piece having a faux embossment having a raised, three dimensional image; and
collecting said faux embossed business communication piece.

8. A method as recited in claim 7, including a further step of printing said substrate at least prior to the step of applying a coating to said substrate.

9. A method as recited in claim 7, including a further step of folding said business communication piece after the step of curing.

10. A method as recited in claim 7, including a further step of cutting said business communication piece after the step of curing.

11. A method as recited in claim 7, wherein said step of curing is accomplished through application of radiation.

12. A method as recited in claim 7, wherein said pattern is selected from a group including strips, lines, shapes, spots, dots, elements, discontinuous segments, themes, seasons, events, trade dress, graphics, alpha and numeric characters and combinations thereof.

13. An intermediate having a faux embossment, comprising;
a substrate having first and second faces;
a radiation curable coating applied to at least a portion of one of said first and second faces defining a coated area, said coating remaining substantially on said face;
a raised three dimensional tactilely discemable pattern created in said coated area by contacting said coating with a plate, to create a faux embossment; and
wherein said substrate with said faux embossment is used to create a business communication document.

14. An intermediate as recited in claim 13, wherein said business communication document is selected from a group including presentation folders, and marketing collateral, sell sheets, invitations, business forms, stationery and combinations thereof.

15. An intermediate as recited in claim 13, wherein said intermediate is provided in a cut sheet format.

16. An intermediate as recited in claim 13, wherein said intermediate is provided in a continuous format.

17. A method of producing marketing collateral having faux embossments, comprising the steps of;
creating a pattern unique to an end user;
preparing a plate containing said pattern;
providing a substrate;
applying a curable coating to at least a portion of said substrate;
contacting said plate to said coating to create said pattern in said coating on said substrate; and
curing said coating to create at least a semi permanent, tactilely discernable pattern on said substrate.

18. A method as recited in claim 17, including a further step of printing indicia related to said end user prior to the step of curing said coating.

19. A method as recited in claim 17, wherein said pattern is selected from a group including strips, lines, shapes, spots, dots, elements, discontinuous segments, themes, seasons, events, trade dress, graphics, alpha and numeric characters and combinations thereof.

20. A method as recited in claim 13, wherein a second pattern is created on a distinct portion of said substrate which is distinct from said first pattern.
